(19) United States
(12) Patent Application Publication
(10) Pub. No.: US 2024/0331008 A1
(43) Pub. Date: Oct. 3, 2024

(54) SOCIAL NETWORK INFORMATION BASED RECOMMENDATIONS USING A TRANSFORMER MODEL

(71) Applicant: SONY GROUP CORPORATION, TOKYO (JP)

(72) Inventors: RAKSHA JALAN, SAN DIEGO, CA (US); TUSHAR PRAKASH, SAN DIEGO, CA (US); NAOYUKI ONOE, SAN DIEGO, CA (US)

(21) Appl. No.: 18/598,528

(22) Filed: Mar. 7, 2024

Related U.S. Application Data
(60) Provisional application No. 63/493,377, filed on Mar. 31, 2023.

(51) Int. Cl. G06Q 30/0601; G06Q 50/00

(52) U.S. Cl. CPC G06Q 30/0631; G06Q 50/01

(57) ABSTRACT

Provided is an electronic device for social network information-based recommendation using transformer model. The electronic device receives first history information associated with a set of users for an item of a set of items and determines first similarity information associated with each user with respect to remaining users of the set of users. Further, the electronic device receives social network information associated each user with respect to remaining users of the set of users. The electronic device determines first embedding associated with each user for the item, based on the first history information, the first similarity information, and the social network information. A first transformer model is applied on the first embedding to determine at least user from set of users for the item. First recommendation information including the determined at least one users for the item is rendered.

### CROSS-REFERENCE TO RELATED APPLICATIONS/INCORPORATION BY REFERENCE

This Application also makes reference to U.S. Provisional Application Ser. No. 63/493,377, which was filed on Mar. 31, 2023. The above stated Patent Application is hereby incorporated herein by reference in its entirety.

### FIELD

Various embodiments of the disclosure relate to recommendation systems. More specifically, various embodiments of the disclosure relate to an electronic device and a method for social network information based on recommendation using a transformer model.

### BACKGROUND

Advancements in the field of recommendation systems have led to the development of different types of recommendation models that have capability to provide personalized recommendations to users. The recommendation models may be deployed on application servers or personal devices of users, based on a size of the recommendation models or complexity of operations performed. The recommendation models may be used in diverse fields such as, media and entertainment, finance, e-commerce, retail, banking, telecom, and so on. The recommendation models may enhance an item-search experience and a usage experience of an application. For example, the search experience may be improved if the recommended items are determined based on accurate predictions of user queries for items. User satisfaction may be enhanced if a recommended item interests the user and inspires the user to query for similar items. Further, the recommendation models may facilitate businesses to improve sales of offered items and determine items that may be of interest to users. For example, the sales of the items may improve because the recommendation models may provide the businesses with better understanding of personal requirements and behavior of individual users. Typically, the accuracy or relevancy of a recommendation model may be dependent on the amount of data collected and used to train the recommendation model to predict user preferences. However, there may be scenarios where sufficient amount of data may not be available for the recommendation model to provide accurate or relevant recommendations.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for social network information-based recommendations using transformer model as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a diagram that illustrates an exemplary network environment for social network information-based recommendations using a transformer model, in accordance with an embodiment of the disclosure.

FIG. 2 is a diagram that illustrates an exemplary electronic device of FIG. 1, for social network information-based recommendation generation using a transformer model, in accordance with an embodiment of the disclosure.

FIG. 3 is a diagram that illustrates a processing pipeline for generation of first recommendation information based on social network information, in accordance with an embodiment of the disclosure.

FIG. 4 is a diagram that illustrates a processing pipeline for generation of second recommendation information based on social network information, in accordance with an embodiment of the disclosure.

FIG. 5A is a diagram that illustrates an exemplary shared Bidirectional Encoder Representations from Transformers (BERT) model for generation of recommendations, in accordance with an embodiment of the disclosure.

FIG. 5B is a diagram that illustrates an exemplary first scenario for determination of an embedding for a task (T₁), in accordance with an embodiment of the disclosure.

FIG. 5C is a diagram that illustrates an exemplary second scenario for determination of an embedding for task (T₂), in accordance with an embodiment of the disclosure.

FIG. 6 is a flowchart that illustrates operations for an exemplary method for social network information-based recommendations using a transformer model, in accordance with an embodiment of the disclosure.

### DETAILED DESCRIPTION

The following described implementations may be found in a disclosed electronic device and method for social network information-based recommendations using transformer model. Exemplary aspects of the disclosure provide an electronic device (for example, a mobile phone, a smart phone, a desktop, a laptop, a personal computer, and the like) that may generate embeddings, and update or modify embeddings associated with users, based on the transformer models for generation of recommendations. The electronic device may receive first history information associated with a set of users (for example, users u1, u2, u3, . . . ) for an item of a set of items (for example, items v1, v2, . . . ). The electronic device may further determine first similarity information associated with each user (e.g., the user u1) of the set of users with respect to remaining users (e.g., the users u2, u3, . . . ) of the set of users. The electronic device may also receive social network information 210C associated each user (e.g., the user u1) of the set of users with respect to remaining users (e.g., the users u2, u3, . . . ) of the set of users. The electronic device may further determine a first embedding associated with each user of the set of users for the item, based on the received first history information, the determined first similarity information, and the received social network information 210E. A first transformer model may be applied on the determined first embedding to determine at least one user from the set of users based on the application of the first transformer model. Further, first recommendation information including the determined at least one user for the item may be rendered.

Typically, the accuracy or relevancy of a recommendation model may be dependent on the amount of data collected and used to train the recommendation model to predict user preferences. However, there may be scenarios where a sufficient amount of data may not be available for the recommendation model to provide accurate or relevant recommendations. In order to address such issues, the disclosed electronic device may generate a recommendation model that may be based on the social network information of the set of users, the history information, and the similarity information. The history information (for example, the first history information) associated with a set of users for an item of a set of items may be received. The similarity information (for example, the first similarity information) may be determined, wherein the first similarity information may be associated with each user of the set of users with respect to remaining users of the set of users. The first embedding associated with each user of the set of users for the item may be determined, based on the received history information (for example, the first history information), the determined similarity information (for example, the first similarity information), and the received social network information. The transformer model (for example, a first transformer model) may be applied on the determined embedding (for example, first embedding) and at least one user may be determined from the set of users based on the application of the transformer model. Recommendation information (such as, the first recommendation information) including the determined at least one user for the item may be rendered.

The disclosed recommendation model may recommend users associated with an item (for example a first item, a second item, and the like) based on the history information (for example, the first history information) for the users for the item, the social network information of the users, and the similarity information (e.g., the first similarity information) of the users. The disclosed electronic device may leverage the history information, the social network information, and the similarity information to determine correlation amongst the users and correlation between the users and the items. A recommendation model (e.g., the first transformer model) of the disclosure may determine recommendations of suitable users for the items based on the determined correlation amongst the users and correlation between the users and the items. Data insufficiency issues like “data sparsity” or “cold start” may be avoided as even if the history information is sparse, the social network information and the similarity information may be leveraged to determine the correlation amongst users and the correlation between the users and the items. For example, users connected on a social media platform and also with common connections (based on the social network information) may have similar interests. Further, users with similar preferences (based on the similarity information) may also be similar to common interests. Hence, such similar users (on the social media platform and otherwise with known similar preferences) may be correlated. Irrespective of whether an user-item history (i.e., the history information) is sparse or incomplete, a recommendation model trained on the social network information and the similarity information may provide accurate recommendations.

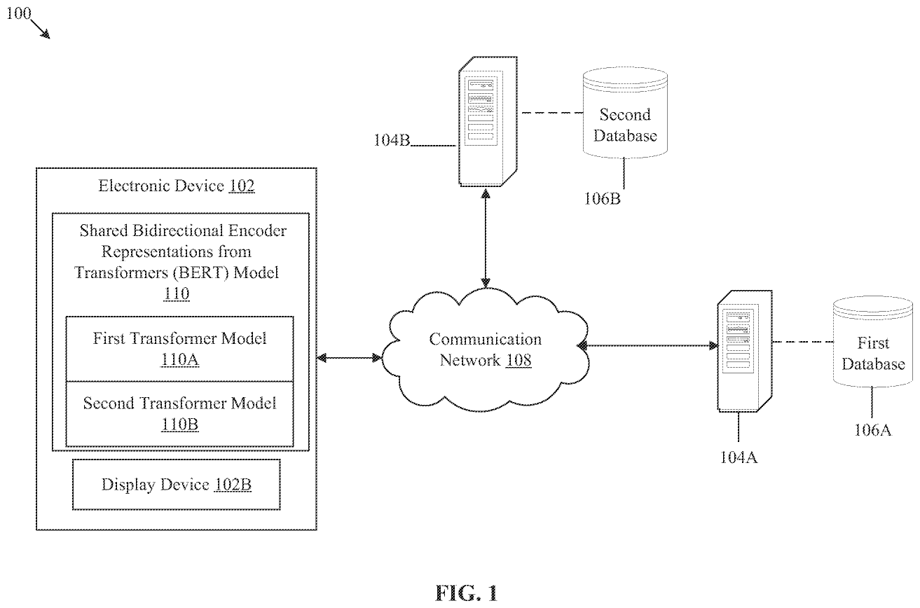

FIG. 1 is a diagram that illustrates an exemplary network environment for social network information-based recommendations using a transformer model, in accordance with an embodiment of the disclosure. With reference to FIG. 1, there is shown a network environment 100. The network environment 100 includes an electronic device 102 and a set of servers (such as, a first server 104A and a second server 104B). The electronic device 102 may communicate with the set of servers (such as, the first server 104A and the second server 104B) through one or more networks (such as, a communication network 108). The first server 104A may be associated with a first database 106A and a second server 104B may be associated with a second database 106B The electronic device 102 may include a shared Bidirectional Encoder Representations from Transformers (BERT) model 102A and a display device 102B. The shared BERT model 102A may further include a first transformer model 110A and a second transformer model 110B. The first database 106A may include history information and similarity information. The second database 106B may include social network information. The display device 102B may be configured to render recommended users for an item and recommended items for a user. For example, the users may include a user u₁, a user u₂, . . . and a user uₙ, and the items may include an item v₁, an item v₂, . . . and an item vₙ. In another embodiment, the user may be a first user, a second user associated with the electronic device 102.

The electronic device 102 may include suitable logic, circuitry, interfaces, and/or code that may be configured to receive first history information associated with a set of users for an item of a set of items. The electronic device 102 may further determine first similarity information associated with each user of the set of users with respect to remaining users of the set of users. The electronic device 102 may receive social network information associated each user of the set of users with respect to remaining users of the set of users history information. The electronic device 102 may determine a first embedding associated with each user of the set of users for the item, based on the received first history information, the determined first similarity information, and the received social network information. The electronic device 102 may apply the shared BERT model 102A (for example, the first transformer model 110A) on the determined first embedding. Further, the electronic device 102 may determine at least one user from the set of users based on the application of the first transformer model 110A. The electronic device 102 may render recommendation information (for example, first recommendation information) including the determined at least one user for the item. For example, the electronic device 102 may be associated with the display device 102B and may render the recommendation information on the display device 102B. Examples of the electronic device 102 may include, but may not be limited to, a desktop, a tablet, a television (TV), a laptop, a computing device, a smartphone, a cellular phone, a mobile phone, a recommendation system, a consumer electronic (CE) device having a display.

The network environment 100 may include a set of servers including, for example, the first server 104A and second server 104B, that may include suitable logic, circuitry, interfaces, and/or code configured to receive requests from the electronic device 102 for information associated with a set of users and/or a set of items associated with the set of users. The first server 104A may be configured to extract the history information and the similarity information from the first database 106A, based on a request for the history information and the similarity information received from the electronic device 102. Further, the second server 104B may be configured to extract the social network information from the second database 106B, based on a request for the social network information received from the electronic device 102. The first server 104A may transmit the extracted history information and the extracted similarity information to the electronic device 102, while the second server 104B may transmit the extracted social network information to the electronic device 102. In some embodiments, at least one of the first server 104A or the second server 104B may be configured to store the shared BERT model 102A (e.g., the first transformer model 110A and the second transformer model 110B). In an embodiment, the first server 104A and/or the second server 104B may be configured to determine recommendation information, such as, first recommendation information (including at least one user for the set of items) or second recommendation information (including at least one item for the set of users). The recommendation information may be determined based on an application of the shared BERT model 102A (e.g., the first transformer model 110A and/or the second transformer model 110B) on the extracted information (e.g., the history information, the similarity information, and the social network information). Further, the set of servers (e.g., the first server 104A and/or the second server 104B) may transmit the recommendation information to the electronic device 102 (for rendering of the transmitted recommendation information on the electronic device 102). The set of servers (e.g., the first server 104A and/or the second server 104B) may execute operations through web applications, cloud applications, HTTP requests, repository operations, file transfer, and the like. Example implementations of the set of servers (e.g., the first server 104A and/or the second server 104B) may include, but are not limited to, a database server, a file server, a web server, an application server, a mainframe server, a cloud computing server, or a combination thereof.

In at least one embodiment, the set of servers (e.g., the first server 104A and/or the second server 104B) may be implemented as a plurality of distributed cloud-based resources by use of several technologies that are well known to those ordinarily skilled in the art. A person with ordinary skill in the art will understand that the scope of the disclosure may not be limited to the implementation of the set of servers (e.g., the first server 104A and/or the second server 104B) and the electronic device 102 as separate entities. In certain embodiments, the functionalities of the set of servers may be incorporated as a single server and/or may be incorporated in its entirety or at least partially in the electronic device 102, without a departure from the scope of the disclosure.

The network environment 100 may further include a set of databases, for example, the first database 106A and the second database 106B, that may include suitable logic, circuitry, interfaces, and/or code configured to configured to store information associated with the set of users and the set of items corresponding to the set of users. The first database 106A may be associated with the first server 104A and the second database 106B may be associated with the second server 104B. In an example, the first database 106A may include the history information (such as, first historical information related to the set of users for an item, and second historical information related to the set of items for a user). The first database 106A may further include the similarity information (such as, first similarity information of each user with respect to remaining users from the set of users, and second similarity information of each item with respect to remaining items from the set of items). In an example, the second database 106B may include the social network information related to each user with respect to remaining users from the set of users. Each of the set of databases (e.g., the first database 106A and the second database 106B) may be derived from data off a relational or non-relational database or a set of comma-separated values (csv) files in conventional or big-data storage. The set of databases may be stored or cached on one or more devices or servers, such as the set of servers (e.g., the first server 104A and the second server 104B). The device storing a database may be configured to query the database for the certain information (such as, the historical information, the similarity information, and/or the social network information) based on reception of a request for the particular information from the electronic device 102. In response, the device storing the database may be configured to retrieve, from the database, results (for example, records related to the queried information) based on the received query.

In some embodiments, the set of databases may be hosted on a plurality of servers stored at same or different locations. The operations of the set of databases may be executed using hardware including a processor, a microprocessor (e.g., to perform or control performance of one or more operations), a field-programmable gate array (FPGA), or an application-specific integrated circuit (ASIC). In some other instances, the database 112 may be implemented using software.

The communication network 108 may include a communication medium through which the electronic device 102 and the set of servers (e.g., the first server 104A and the second server 104B) may communicate with each other. The communication network 108 may be a wired or wireless communication network. Examples of the communication network 108 may include, but are not limited to, Internet, a cloud network, Cellular or Wireless Mobile Network (such as Long-Term Evolution and 5th Generation (5G) New Radio (NR)), satellite communication system (using, for example, low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 108, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The shared BERT model 102A (for example, the first transformer model 110A, second transformer model 110B) may be a neural network architecture. The shared BERT model 102A may be a machine learning model that can compare and generate inferences based on received data input (for example, similarity information of a user, history information of a user or an item, social network information of a user, and so on). The shared BERT model 102A may work based on learning of context and meaning of words from large amounts of unlabeled text data, and then fine-tuning the model for specific tasks using labeled data. The shared BERT model 102A may process both left and right context of each data input. The shared BERT model 102A may include an embedding module, a stack of encoders, and an un-embedding module. The shared BERT model 102A may be pre-trained on two tasks, such as, masked language modeling (MLM) and next-data-item prediction (for example, data items, such as, users and items). The MLM may randomly mask some tokens in the input data and predict the inference based on the context. The shared BERT model 102A may include a set of nodes that may be associated with a set of users or a set of items. The nodes may represent embeddings associated with the set of users and/or the set of items. For example, a node associated with a user may be representative of a second embedding associated with the user. Each node may be connected to a plurality of nodes that may be neighbors of the corresponding node in a graphical representation of the data. For example, the node associated with the user may be connected to nodes associated with users that may be determined as neighbors of the user, based on the first correlation information. The correlation information may be determined based on the similarity information of the set of users. In an instance, the first similarity information may be determined based on the received second correlation information.

In another example, the node associated with the user may be representative of an item embedding associated with the item. Each node may be connected to a plurality of nodes that may be neighbors of the corresponding node in the graphical representation of the data. For example, the node associated with the item may be connected to nodes associated with items that may be determined as neighbors of the items, based on the second correlation information. The correlation information may be determined based on the similarity information of the set of users. In an instance, the second similarity information may be determined based on the received first correlation information.

The shared BERT model 102A may capture weights via an attention mechanism. The nodes may be associated with the captured weights, which may be determined based on the correlation information (i.e., the first correlation information and the second correlation information). Each node of the shared BERT model 102A may represent a set of node features. The set of node features represented by a node may correspond to features used to generate embeddings represented by the node. Thereafter, an updated set of node features may be generated, based on the shared BERT model 102A. The updated set of node features may be representative of recommendation information (for example, the first recommendation information and the second recommendation information) including a user (from the set of users) for the set of items or an item (from the set of items) for the set of users.

In an embodiment, the shared BERT model 102A (e.g., the first transformer model 110A and the second transformer model 110B) may correspond to a neural network. The neural network may be a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before, while training, or after training the neural network on a training dataset.

Each node of the neural network may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to same or a different same mathematical function.

In training of the neural network, one or more parameters of each node of the neural network may be updated based on whether an output of the final layer for a given input (from the training dataset) matches a correct result based on a loss function for the neural network. The above process may be repeated for same or a different input until a minima of loss function may be achieved and a training error may be minimized. Several methods for training are known in art, for example, gradient descent, stochastic gradient descent, batch gradient descent, gradient boost, meta-heuristics, and the like.

The neural network may include electronic data, which may be implemented as, for example, a software component of an application executable on the electronic device 102. The neural network may rely on libraries, external scripts, or other logic/instructions for execution by a processing device, such as, a processor/circuitry of the electronic device 102. The neural network may include code and routines configured to enable the electronic device 102 to perform one or more operations for a determination of a first recommendation of a user for the set of items and/or a determination of a second recommendation of an item for the set of users. Additionally or alternatively, the neural network may be implemented using hardware including a processor, a microprocessor (e.g., to perform or control performance of one or more operations), a field-programmable gate array (FPGA), or an application-specific integrated circuit (ASIC). Alternatively, in some embodiments, the neural network may be implemented using a combination of hardware and software.

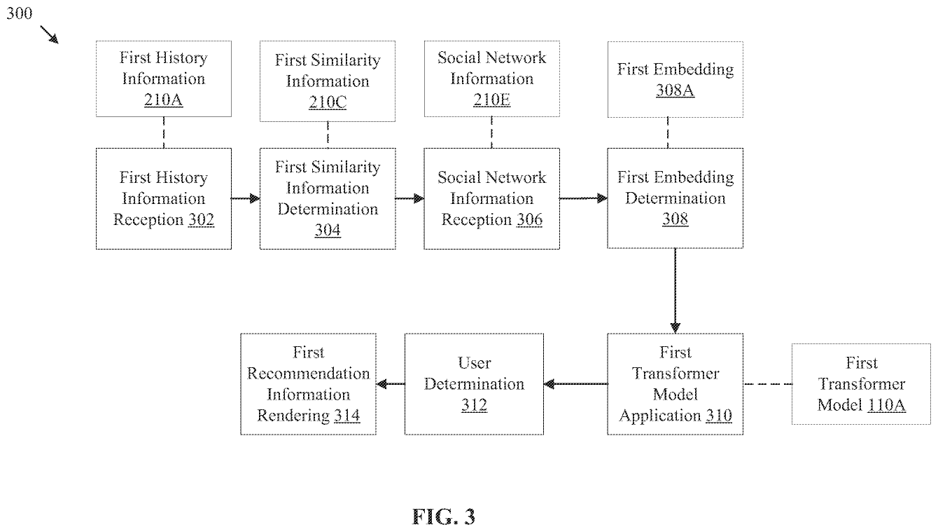

In operation, the electronic device 102 may be configured to receive first history information associated with a set of users for an item of a set of items. The received first history information may indicate a historical interaction between the users and a certain item. For example, in case, the item is a movie, the first historical information may indicate a rating provided to the movie by the set of users, or which users have viewed the movie. The reception of the first history information is described further, for example, in FIG. 3 (at 302).

The electronic device 102 may be configured to determine first similarity information associated with each user of the set of users with respect to remaining users of the set of users. For example, the first similarity information may correspond to a similarity score of a user with respect to each of the remaining users of the set of users. In an example, the similarity score may correspond to a degree of similarity of interests of the users, a degree of similarity of background information of the users, and/or a degree of similarity of items associated with the users (e.g., more the number of common items between two users, higher may be the similarity score between the two users). The determination of the first similarity information is described further, for example, in FIG. 3 (at 304).

The electronic device 102 may be configured to receive social network information associated each user of the set of users with respect to remaining users of the set of users. The social network information may indicate whether two users are connected directly or indirectly on a social media platform. Also, the social network information may indicate a degree of connectivity between two users. For example, a first user and a second user may not be directly connected on the social media platform, and the two users may have common connections. In an example, the common connections may be directly connected to both the users. In such case, the degree of connectivity between the two users may be 2 (e.g., a friends-of-friends connection). In another example, the common connections may be indirectly connected to both the users. In such case, the degree of connectivity between the two users may be 3 or more (e.g., connections who may be a friend of friends-of-friends of the two users). The reception of the social network information is described further, for example, in FIG. 3 (at 306).

The electronic device 102 may be configured to determine a first embedding associated with each user of the set of users for the item, based on the received first history information, the determined first similarity information, and the received social network information. For example, the electronic device 102 may apply an input layer of a neural network model to determine the first embedding associated with each user of the set of users for the item. The first embedding may correspond to a vector representation of the first history information, the determined first similarity information, and the received social network information. The determination of the first embedding is described further, for example, in FIG. 3 (at 308).

The electronic device 102 may be configured to apply a first transformer model (e.g., the first transformer model 110A) on the determined first embedding. For example, the first transformer model 110A may correspond to neural network model, such as, a BERT-based language model. The application of the first transformer model is described further, for example, in FIG. 3 (at 310). The electronic device 102 may be configured to determine at least one user from the set of users based on the application of the first transformer model 110A. For example, the electronic device 102 may use a recommendation model to determine the at least one user, based on the application of the first transformer model 110A. The determination of the at least one user is described further, for example, in FIG. 3 (at 312). Further, the electronic device 102 may be configured to render first recommendation information including the determined at least one user for the item. The rendering of the first recommendation information is described further, for example, in FIG. 3 (at 314).

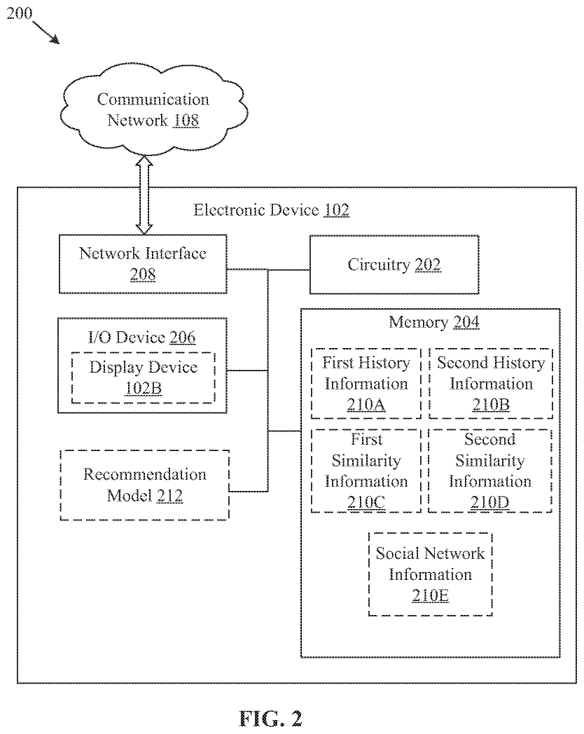

FIG. 2 is a diagram that illustrates an exemplary electronic device of FIG. 1, for social network information-based recommendation generation using a transformer model, in accordance with an embodiment of the disclosure. FIG. 2 is explained in conjunction with elements from FIG. 1. With reference to FIG. 2, there is shown a diagram 200 of the electronic device 102. The electronic device 102 may include circuitry 202, a memory 204, an input/output (I/O) device 206, a network interface 208, the shared BERT model 102A (including the first transformer model 110A and the second transformer model 110B), and the recommendation model 212. In at least one embodiment, the I/O device 206 may also include the display device 102B. In at least one embodiment, the memory 204 may include first history information 210A, second history information 210B, first similarity information 210C, second similarity information 210D, and social network information 210E. The circuitry 202 may be communicatively coupled to the memory 204, the I/O device 206, the network interface 208, the recommendation model 212 through wired or wireless communication of the electronic device 102.

The circuitry 202 may include suitable logic, circuitry, and interfaces that may be configured to execute program instructions associated with different operations to be executed by the electronic device 102. The operations may include the reception of the first history information 210A, the determination of the first similarity information 210C, and the reception of the social network information 210E. The operations may further include the determination of the first embedding, the application of the first transformer model 110A, the determination and rendering of the first recommendation information including at least one user for the set of items. The circuitry 202 may include one or more specialized processing units, which may be implemented as an integrated processor or a cluster of processors that perform the functions of the one or more specialized processing units, collectively. The circuitry 202 may be implemented based on a number of processor technologies known in the art. Examples of implementations of the circuitry 202 may be an x86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other computing circuits.

The memory 204 may include suitable logic, circuitry, interfaces, and/or code that may be configured to store the program instructions to be executed by the circuitry 202. The program instructions stored on the memory 204 may enable the circuitry 202 to execute operations of the circuitry 202 (and/or the electronic device 102). In at least one embodiment, the memory 204 may store the first history information 210A, the second history information 210B, the first similarity information 210C, the second similarity information 210D, and the social network information 210E. The memory 204 may further store first recommendation information (not shown in FIG. 2) and/or second recommendation information (not shown in FIG. 2). Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. For example, the I/O device 206 may receive a user input from the user. The user input may be indicative of information of the user and one or more items (e.g., movies/video content) consumed (or viewed) by the user. In some embodiments, the I/O device 206 may receive a user input from the user that may be indicative of a relevancy rating associated with a rendered recommendation. The relevancy rating may indicate whether the recommendation is relevant to the user or whether the user is interested in one or more items included in the recommendation. Examples of the I/O device 206 may include, but are not limited to, a touch screen, a keyboard, a mouse, a joystick, a microphone, the display device 102B, and a speaker. Examples of the I/O device 206 may further include braille I/O devices, such as, braille keyboards and braille readers.

The I/O device 206 may include the display device 102B. The display device 102B may include suitable logic, circuitry, and interfaces that may be configured to receive inputs from the circuitry 202 to render, on a display screen, one or more users recommended for the set of items (i.e., the first recommendation information) and/or one or more items recommended for the set of users (i.e., the second recommendation information). In at least one embodiment, the display screen may be at least one of a resistive touch screen, a capacitive touch screen, or a thermal touch screen. The display device 102B or the display screen may be realized through several known technologies such as, but not limited to, at least one of a Liquid Crystal Display (LCD) display, a Light Emitting Diode (LED) display, a plasma display, or an Organic LED (OLED) display technology, or other display devices 102B.

The network interface 208 may include suitable logic, circuitry, and interfaces that may be configured to facilitate communication between the circuitry 202, the first server 104A, and the second server 104B, via the communication network 108. The network interface 208 may be implemented by use of various known technologies to support wired or wireless communication of the electronic device 102 with the communication network 108. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via wireless communication with networks, such as the Internet, an Intranet, or a wireless network, such as a cellular telephone network, a wireless local area network (LAN), a short-range network, and a metropolitan area network (MAN). The wireless communication may use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a near field communication protocol, and a wireless pear-to-pear protocol.

The recommendation model 210 may be based on a matrix factorization and/or deep learning based neural network. For example, the recommendation model 210 may be a collaborative filtering-based model. The recommendation model 210 may be trained to determine a diversity between the users and items based on various parameters, such as, the history information, the similarity information, the social network information 210E, and relationships between entities (for example, users of the set of users or the items of set of items). The recommendation model 210 may receive, as inputs, the first embeddings of each user of the set of users or second embeddings of each item of the set of items. For, example, the recommendation model 210 may receive the first embeddings (for example, u₁, [mask], u₃, . . . uₙ) for a task T₂. The recommendation model 210 may update the first embedding associated with the items. The updated first embedding associated with the item may be used to recommend users associated with the item. The functions or operations executed by the electronic device 102, as described in FIG. 1, may be performed by the circuitry 202. Operations executed by the circuitry 202 are described in detail, for example, in FIGS. 3, 4, 5A, 5B, 5C and 6.

FIG. 3 is a diagram that illustrates a processing pipeline for generation of first recommendation information based on social network information, in accordance with an embodiment of the disclosure. FIG. 3 is explained in conjunction with elements from FIG. 1 and FIG. 2. With reference to FIG. 3, there is shown an exemplary execution pipeline 300 for generation of first recommendation information. The execution pipeline 300 may include operations 302 to 314 executed by a computing device, such as, the electronic device 102 of FIG. 1 or the circuitry 202 of FIG. 2.

At 302, first history information may be received. The circuitry 202 may be configured to receive the first history information 210A. The first history information 210A may be associated with a set of users for an item of the set of items. The first history information 210A of the users associated with an item may be fed to the recommendation model 210. The recommendation model 212 may be a neural network that may estimate a probability of current/future user-item interactions based on their previous user-item interactions (indicated in the first history information 210A). For example, if a user has watched many movies of a certain genre, the recommendation model 212 may recommend similar movies of the particular genre that the user might like. The first history information 210A may be stored in the first database 106A. The first server 104A may retrieve the first history information 210A from the first database 106A and transmit the retrieved first history information 210A to the electronic device 102. In an alternate embodiment, the first history information 210A may be pre-stored in the memory 204 of the electronic device 102. In such case, the circuitry 202 may retrieve the first history information 210A from the memory 204.

At 304, first similarity information may be determined. The circuitry 202 may be configured to determine the first similarity information 210C. The first similarity information 210C may be associated with each user of the set of users with respect to remaining users of the set of users. The first similarity information 210C may be determined based on correlation information (e.g., the second correlation information) associated with the set of users for the item of the set of items. The second correlation information associated with the set of users may be received for the item of the set of items. For example, the circuitry 202 may receive the second correlation information from the first database 106A, via the first server 104A. In an embodiment, the first server 104A may generate the first similarity information 210C based on the second correlation information and store the generated first similarity information 210C in the first database 106A. The electronic device 102 may receive the first similarity information 210C from the first database 106A, via the first server 104A. The first similarity information 210C may be fed to the recommendation model 212 to compare similarity measures between the users, in order to generate recommendations. For example, the similarity measures (e.g., based on the second correlation information) between the users may be based on various factors, such as ratings, content, or behavior. Different similarity measures may have different effects on the performance and accuracy of the recommendation model 212. Some examples of the similarity measures may be, but are not limited to, a cosine similarity, a Jaccard similarity, a Pearson correlation, and a Euclidean distance. The circuitry 202 may generate recommendations based on the user behavior or user-user behavior. The user-user behavior may be used to determine recommendations for users based on the behavior of the remaining users from past or current actions (for example, the actions may be other similar users from the set of users). In another instance, the user-user behavior may be used to determine recommendations for users based on the social network information 210E of the users, as described at 306. The circuitry 202 may capture dynamic and complex preferences of users in different contexts and scenarios, such as, e-commerce, music, or news. The recommendation model 212 may generate the recommendations based on collaborative filtering, neural networks, or graph neural networks. Various techniques may be used to model a user-user matrix, which includes values indicative of a user's preference towards the given set of users. The values in the user-user matrix may be derived from explicit feedback (such as, ratings) or implicit feedback (such as clicks, views, or purchases).

At 306, social network information may be received. The circuitry 202 may be configured to receive the social network information 210E. The social network information 210E may be associated with each user of the set of users with respect to remaining users of the set of users. The circuitry 202 of the electronic device 102 may receive the social network information 210E from the second database 106B, via the second server 104B. For example, the second server 104B may retrieve the social network information 210E from the second database 106B and transmit the retrieved social network information 210E to the electronic device 102, based on receipt of a query/request for the social network information 210E from the electronic device 102. In another embodiment, the social network information 210E may be stored in the memory 204. In such case, the circuitry 202 may retrieve the social network information 210E from the memory 204.

The social network information 210E may be a set of relationships (e.g., direct/indirect connections) between a user and other users on one or more social media platforms or a set of preferences corresponding to the set of items for each of the set of users. The social network information 210E of the user may be used to determine suggestions or recommendations associated with the user or other similar users based on social connections, interactions, and preferences of the users. The social network information 210E may include diverse information of the set of users from social networks, such as, user profiles, ratings, reviews, comments, likes, shares, follows, etc. The social network information 210E may be used to improve the quality and the diversity of recommendations by the recommendation model 212. The recommendation model 212 may use the social network information 210E and determine recommendations, based on implementation of various techniques, such as, matrix factorization, graph neural networks, attention mechanisms, etc. Such techniques may be used to model the user-item matrix, which may include values indicative of a user's preference towards a given item and similarity between users based on social media connectivity. The values may be derived from a user's connectivity graphs on the social media network, explicit feedback (such as ratings) or implicit feedback (such as clicks, views, or purchases). Various techniques may be used to incorporate the social network information 210E as a basis for determination of recommendations by the recommendation model 212. Examples of such techniques may include, but are not limited to, social regularization, social propagation, social aggregation, etc. Such techniques may use different ways to capture the influence of the social neighbors, the social trust, the social similarity, the social context, etc., on the user's preferences.

At 308, a first embedding may be determined. The circuitry 202 may be configured to determine a first embedding (e.g., a first embedding 308A) associated with each user of the set of users for the item, based on the received first history information 210A, the determined first similarity information 210C, and the received social network information 210E. In an embodiment, the first embedding 308A may combine the first history information 210A, the first similarity information 210C and the social network information 210E to generate a vector with numerical values as the first embedding 308A. In some embodiments, to generate the first embedding 310A, the circuitry 202 may be configured to execute a prioritization of influential neighboring vectors and execute a neighborhood sampling with multinomial distribution. The circuitry 202 may be configured to determine neighborhood information associated with the set of users and a user associated with the set of items, based on the determined second correlation information.

In accordance with an embodiment, the circuitry 202 may be configured to determine neighborhood information (e.g., second neighborhood information) associated with a user “U₁”, based on correlation information (e.g., second correlation information, i.e., a user-user similarity matrix). The determined neighborhood information may be indicative of users of the set of users (i.e., the users “U₁”, . . . , “U_{N}”) who may be correlated to the user “U₁”. The circuitry 202 may determine the users, who may be correlated with the user “U₁”, based on a comparison of the score of the user “U₁” with respect to each of the users “U₂”, . . . “U_{N}” with a predefined threshold. The circuitry 202 may obtain the score of the user “U₁” with respect to each of the users “U₂”, . . . “U_{N}” based on the first row of the user-user matrix. The comparison may indicate that the score of the user “U₁” with respect to each user correlated to the user “U₁” may be greater than the predefined threshold. The users of the set of users who may be correlated to the user “U₁” (i.e., the first user or the user 116) may correspond to users neighboring (i.e., similar users) to the user “U₁” with respect to an item V₁. Thus, the second correlation information (i.e., the user-user matrix 306) may include the first neighborhood information and information pertaining to the association between the multiple users or the first user (i.e., the user “U₁”) and the items (i.e., the user “V₁”). The circuitry 202 may similarly determine neighborhood information associated with each of the remaining users of the first set of users associated with the item, based on the correlation information (i.e., the user-user matrix).

At 310, a first transformer model may be applied on the determined first embedding. The circuitry 202 may be configured to apply a first transformer model (e.g., the first transformer model 110A) on the determined first embedding 308A. The first transformer model 110A may include an objective function L to determine a first recommendation of users relevant to a certain item. The L₁ may represent a cross entropy loss function for T₁ (for example, a task to recommend users for a certain item, based on item embeddings). The L₂ may represent a cross entropy loss function for T₂ (for example, a task to recommend items for a certain user, based on user embeddings). In an embodiment, the second correlation information may correspond to a masked (e.g., cloze-masked) user from the set of users, for an item. The first transformer model 110A may be trained based on the masked user corresponding to the item. The first transformer model 110A may include an item sequence header (Eᵥ_{ⱼ}) for a set of first embeddings of the set of users (for example, E_{β}^{u}^{₁} . . . E_{β}^{u}^{_{m−1}} . . . E_{β}^{u}^{ₘ}) for the item (i.e., Vⱼ).

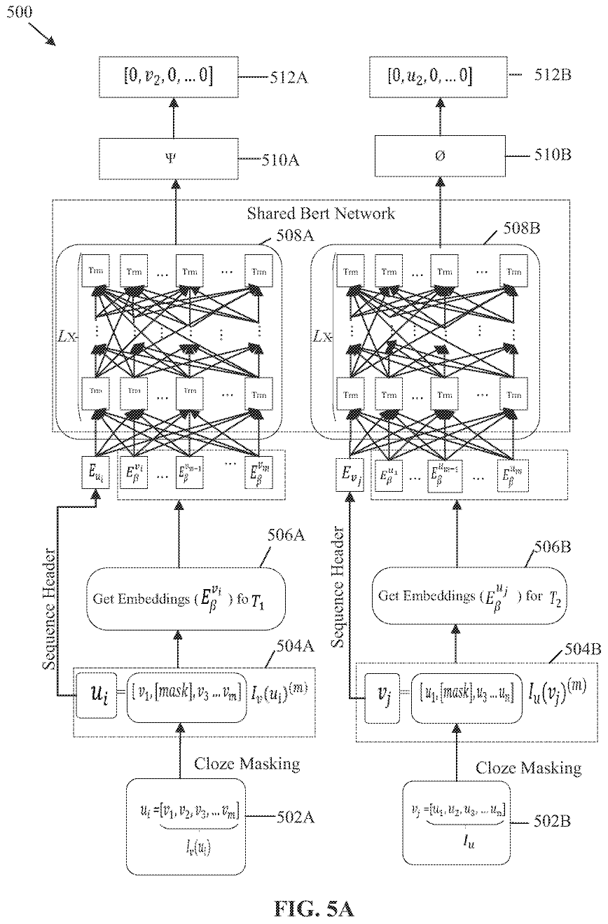

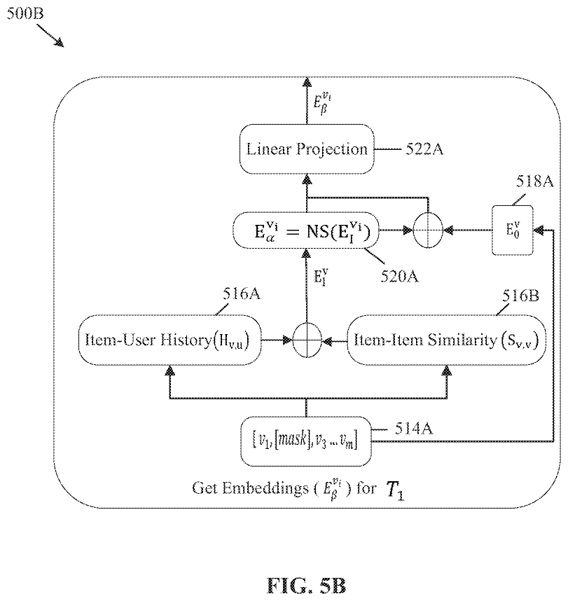

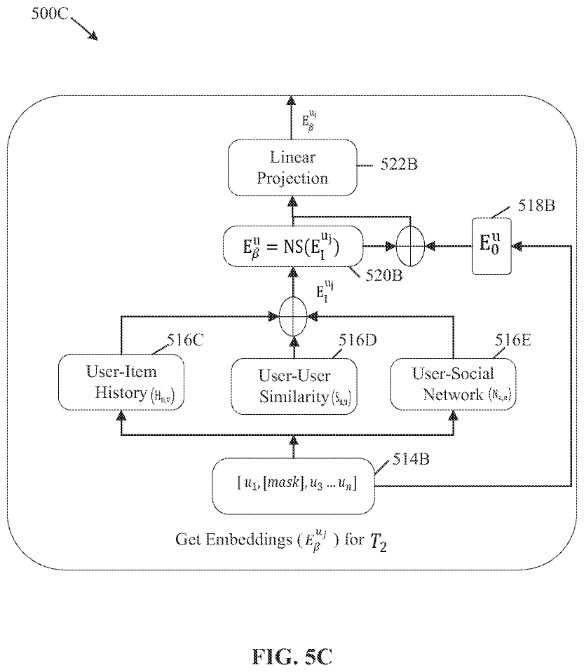

The nodes of the first transformer model 110A may represent the first embeddings 308A associated with the set of users of the items (Vⱼ). For example, a portion of the first transformer model 110A (from the viewpoint of the node associated with the user) may include 5 nodes. The nodes may be associated with the user and the 4 other similar users. The nodes associated with the item sequence header may be connected to the node associated with the users (for example, E_{β}^{u}^{₁} . . . E_{β}^{u}^{_{m−1}} . . . E_{β}^{u}^{ₘ}). The first transformer model 110A may further determine the masked (e.g., cloze-masked) users, for each node associated with the users with respect to the set of users. Details related to the application of the first transformer model are described further, for example, in FIGS. 5A and 5C.

At 312, at least one user may be determined from the set of users for an item. The circuitry 202 may be configured to determine the at least one user (e.g., a user-1 312A and a user-2 312B) from the set of users for an item (e.g., an item-1 312C) based on the application of the first transformer model 110A. The first embedding 308A may be fed to the first transformer model 110A as an input and the circuitry 202 may use the first transformer model 110A to determine an inference based on the fed first embedding 308A. The inference of the first transformer model 110A may correspond to the at least one user (e.g., the user-1 312A and the user-2 312B) from the set of users for an item (e.g., the item-1 312C). The inference may be determined, for example, as an array (0, u₂, 0 . . . 0), The first transformer model 110A and the second transformer model 110B may correspond to the shared BERT model 102A. The shared BERT model 102A may determine an output, based on the following equations (1) and (2):

$$ℒ ( {E}_{β}^{v} , {E}_{β}^{u} , θ , φ , ∅ ) = {ℒ}_{1} ( φ ( θ ( {E}_{β}^{v} ) ) , {V}_{0} ) + α ( {ℒ}_{2} ( ∅ ( θ ( {E}_{β}^{u} ) ) , {U}_{0} ) \qquad ( 1 )$$

$$c ( θ , ϕ , ∅ ) arg min ℒ ( {E}_{β}^{v} , {E}_{β}^{u} , θ , φ , ∅ ) ] \qquad ( 2 )$$

where L₁ and L₂ are cross entropy loss functions for tasks T₁ and T₂, respectively, V₀ and U₀ may be the masked values for items and users, respectively, and α may be a weight given to an auxiliary task.

At 314, first recommendation information may be rendered. The circuitry 202 may be configured to render first recommendation information (e.g., first recommendation information 314A) including the determined at least one user (e.g., the user-1 312A and the user-2 312B) for the item (e.g., the item-1 312C). The first recommendation information 314A may be rendered on the display device 102B associated with the electronic device 102.

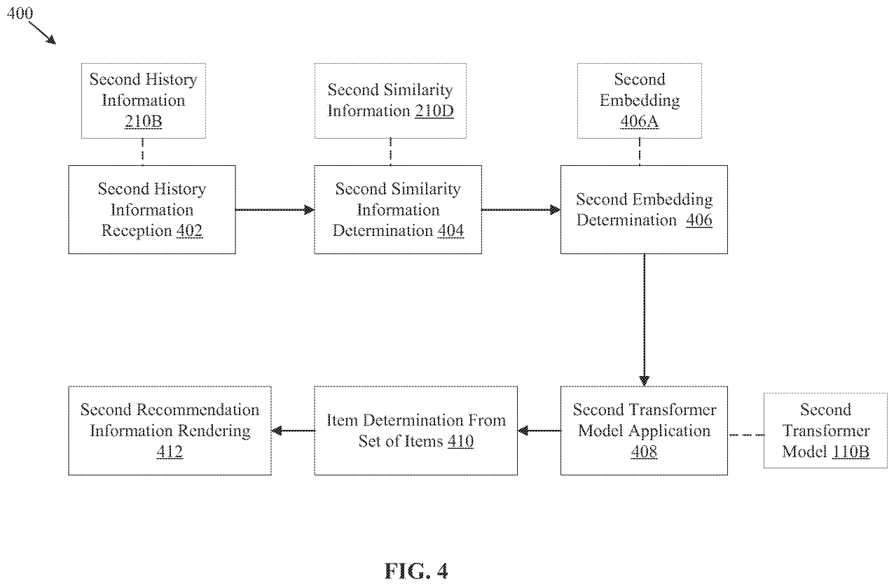

FIG. 4 is a diagram that illustrates a processing pipeline for generation of second recommendation information based on social network information, in accordance with an embodiment of the disclosure. FIG. 4 is explained in conjunction with elements from FIG. 1, FIG. 2, and FIG. 3. With reference to FIG. 4, there is shown an exemplary execution pipeline 400 for generation of second recommendation information. The execution pipeline 400 may include operations 402 to 412 executed by a computing device, such as, the electronic device 102 of FIG. 1 or the circuitry 202 of FIG. 2.

At 402, second history information may be received. The circuitry 202 may be configured to receive second history information (e.g., the second history information 210B) associated with the set of items for the user of the set of users. The second history information 210B may include item-user history or user-item history information.

The second history information 210B of the items associated with a user may be fed to the recommendation model 210. The recommendation model 212 may be a neural network that may estimate a probability of current/future item-user interactions based on their previous item-user interactions (indicated in the second history information 210B). For example, if one or more movies (referred as, items) are watched by many users of the set of users (wherein the set of users may watch movies of a certain genre), the recommendation model 212 recommend such one or more movies with similar context for the users who prefer movies of the related genre. The second history information 210B may be stored in the first database 106A. The first server 104A may retrieve the second history information 210B from the first database 106A and transmit the retrieved second history information 210B to the electronic device 102. In an alternate embodiment, the second history information 210B may be pre-stored in the memory 204 of the electronic device 102. In such case, the circuitry 202 may retrieve the second history information 210B from the memory 204.

At 404, second similarity information may be determined. The circuitry 202 may be configured to determine the second similarity information 210D. The second similarity information 210D may be associated with each item of the set of items with respect to remaining items of the set of items. The second similarity information 210D may be determined based on correlation information (e.g., the first correlation information) associated with the set of items for the user of the set of items. The first correlation information associated with the set of items may be received for the user of the set of users. For example, the circuitry 202 may receive the first correlation information from the first database 106A, via the first server 104A. In an embodiment, the first server 104A may generate the second similarity information 210D based on the first correlation information and store the generated second similarity information 210D in the first database 106A. The electronic device 102 may receive the second similarity information 210D from the first database 106A, via the first server 104A. The second similarity information 210D may be fed to the recommendation model 212 to compare similarity measures between the items, in order to generate recommendations. For example, the similarity measures (e.g., based on the first correlation information) between the items may be based on various factors, such as ratings, content, or reviews. Different similarity measures may have different effects on the performance and accuracy of the recommendation model 212. Some examples of the similarity measures may be, but are not limited to, a cosine similarity, a Jaccard similarity, a Pearson correlation, and a Euclidean distance. The circuitry 202 may generate recommendations based on the item properties or item-item correlations. The item-item correlations may be used to determine recommendations for items based on the correlation with the remaining items from past or current interactions (for example, users who took similar actions on a certain item/similar items). The circuitry 202 may capture dynamic and complex preferences of users in different contexts and scenarios, such as, e-commerce, music, or news. The recommendation model 212 may generate the recommendations based on collaborative filtering, neural networks, or graph neural networks. Various techniques may be used to model an item-item matrix, which includes values indicative an item preference of a user with respect to item preferences of the remaining users for a given item. These values can be derived from explicit feedback (such as ratings) or implicit feedback (such as clicks, views, or purchases).

At 406, a second embedding may be determined. The circuitry 202 may be configured to determine a second embedding (e.g., a second embedding 406A) associated with each item of the set of items for the user, based on the received second history information 210B and the determined second similarity information 210D. In an embodiment, the second embedding 406A may combine the second history information 210B and the second similarity information 210D to generate a vector with numerical values as the second embedding 406A. In some embodiments, to generate the first embedding 310A, the circuitry 202 may be configured to execute a prioritization of influential neighboring vectors and execute a neighborhood sampling with multinomial distribution. The circuitry 202 may be configured to determine neighborhood information associated with the set of items and an item associated with the set of users, based on the determined first correlation information. Details related to the determination of the neighborhood information (e.g., first neighborhood information) based on correlation/similarity information (e.g., first correlation information, i.e., an item-item similarity matrix) are described further, for example, in FIG. 3 (308).

At 408, a second transformer model may be applied on the determined second embedding. The circuitry 202 may be configured to apply a second transformer model (e.g., the second transformer model 110B) on the determined second embedding 406A. The second transformer model 110B may include the objective function L to determine second recommendation of items relevant to a certain user. The L₂ may represent a cross entropy loss function for T₂ (for example, a task to recommend items for a certain user, based on user embeddings). In an embodiment, the first correlation information corresponds to masked (e.g., cloze-masked) item from the set of items, for the user, and the second transformer model 110B may be trained based on the masked (e.g., cloze-masked) item corresponding to the user. The second transformer model 110B may include the user sequence header (Eᵤ_{ᵢ}) associated with the set of second embeddings of the set of items (for example, E_{β}^{v}^{₁} . . . E_{β}^{v}^{_{m−1}} . . . E_{β}^{v}^{ₘ}) of the item (uᵢ). To generate the second embedding 406A (e.g., Eₐ^{v}^{ᵢ}), the concatenation of an item array [v₁, [mask], v₃ . . . vₘ] (referred E_{α}^{v}), convolution summation of item-user history and item-item similarity (referred as Eₗ^{v}) may executed. Linear projection of the second embedding (E_{β}^{v}^{ᵢ}) may be fed as input to the shared BERT model 102A. In an embodiment, to place similar user-item pairs in a vector space, a user sequence header (uᵢ) may be used to generate an embedding (Eᵤ), as shown in equation (3):

$${E}_{β}^{v} = {E}_{u} ⊕ σ ( {W}^{T} ( {E}_{0}^{v} ⊕ {E}_{α}^{v} ) ) \qquad ( 3 )$$

where E_{β}^{v} may be a second embedding associated with each item of the set of items for the user.

The nodes of the second transformer model 110B may represent second embeddings associated with each item of the set of items for the user (uᵢ). For example, a portion of the second transformer model 110B (from the viewpoint of the node associated with the user) may include 5 nodes. The nodes may be associated with the items and the 4 other similar items. The nodes associated with the user sequence header may be connected to the node associated with the items (for example, E_{β}^{v}^{₁} . . . E_{β}^{v}^{_{m−1}} . . . E_{β}^{v}^{ₘ}). The second transformer model 110B may further determine the masked items, for each node associated with the item with respect to the set of items. Details related to the application of the first transformer model are described further, for example, in FIGS. 5A and 5B.

At 410, at least one item may be determined from the set of items for a user. The circuitry 202 may be configured to determine the at least one item (e.g., an item-1 410A and an item-2 410B) from the set of items for a user (e.g., a user 410C), based on the application of the second transformer model 110B. The second embedding 406A may be fed to the second transformer model 110B as an input and the circuitry 202 may use the second transformer model 110B to determine an inference based on the fed second embedding 406A. The inference may be determined, for example, as an array (0, v₂, 0 . . . 0). The first transformer model 110A and the second transformer model 110B may correspond to the shared BERT model 102A. The shared BERT model 102A may determine an output, based on the equations (1) and (2), as described, for example, in FIG. 3 (at 312).

At 412, second recommendation information may be rendered. The circuitry 202 may be configured to render second recommendation information (e.g., second recommendation information 412A) including the determined at least one item at least one item (e.g., the item-1 410A and the item-2 410B) from the set of items for a user (e.g., the user 410C). The second recommendation information 412A may be rendered on the display device 102B associated with the electronic device 102.

FIG. 5A is a diagram that illustrates an exemplary shared Bidirectional Encoder Representations from Transformers (BERT) model for generation of recommendations, in accordance with an embodiment of the disclosure. FIG. 5A is explained in conjunction with FIG. 1, FIG. 2, FIG. 3, and FIG. 4. With reference to FIG. 5A, an exemplary shared BERT model 500A is shown.

The shared BERT model 500A (e.g., the shared BERT model 102A) may correspond to a multi-view BERT network (MVBN). In an example, the MVBN may execute a unified aspect-based sentiment analysis (ABSA) as a task with the two subtasks as auxiliary tasks. Further, a representation obtained from a branch network of the main task may correspond to a global view, whereas the representations of the two subtasks may correspond to two local views with different emphases. At 502A, the circuitry 202 may be configured to select an array of items (for example, [v₁, v₂, v₃, . . . vₘ]) for a user uᵢ. The array of the items for the user (uᵢ) may be represented as lᵥ(uᵢ). Similarly, at 502B, the circuitry 202 may be configured to select an array of users (for example, [u₁, u₂, u₃, . . . uₘ]) for an item vⱼ. The array of the users for the item (vⱼ) may be represented as lᵤ.

At 504A, for the user (uᵢ), a set of items may be masked. The circuitry 202 may be configured to mask the set of items for the user (ui). The masked array may be represented as [v₁, [mask], v₃, . . . vₘ]. The masked array for the user (uᵢ) may be lᵥ(uᵢ)^{(m)}. Similarly, at 504B, for the item (vⱼ), a set of users are masked. The circuitry 202 may be configured to mask the set of users for the item (vⱼ). The masked array may be represented as [u₁, [mask], u₃, . . . uₘ]. The masked array for the item (vⱼ) may be lᵤ(vⱼ)^{(m)}.

Further, the circuitry 202 may execute the operations associated with the algorithm of the MVBN, as provided below in Algorithm 1:

Algorithm 1: Algorithm for MVBN:

| | |
|---|---|
| 1: | for each user i, item j in N Users and M Items respectively do |
| 2: | Iᵥ(uᵢ) ← given item input-sequence for user uᵢ |
| 3: | Iᵤ(vⱼ) ← given user input-sequence for item vⱼ |
| 4: | Iᵥ(uᵢ)^{(m)} = Cloze-Masking(Iᵥ(uᵢ)) |
| 5: | Iᵤ(vⱼ)^{(m)} = Cloze-Masking(Iᵤ(vⱼ)) |
| 6: | Hᵥ_{ᵢ}_{v,} Sᵥ_{ᵢ}_{v,} ← Iᵥ(uᵢ)^{(m)} |
| 7: | Hᵤ_{ⱼ}_{v,} Sᵤ_{ⱼ}_{u,} Nᵤ_{ⱼ}_{u,} ← Iᵤ(vⱼ)^{(m)} |
| 8: | E_{β}^{v}^{ᵢ} = get_embeddings(Hᵥ_{ᵢ}_{u,} Sᵥ_{ᵢ}_{v,}, None) |
| 9: | E_{β}^{u}^{ⱼ} = get_embeddings(Hᵤ_{ⱼ}_{v,} Sᵤ_{ⱼ}_{u,} Nᵤ_{ⱼ}ᵤ) |
| 10: | \hat{v} = ϕ(⊖E_{β}^{v}^{ᵢ})), û = ϕ(⊖(E_{β}^{u}^{ⱼ})) |
| 11: | [symbol] _{T}_{₁} = L_{ce}(vₒ, \hat{v}), [symbol] _{T}_{₂} = L_{ce}(uₒ, û) |
| 12: | [symbol] = [symbol] _{T}_{₁} + α * [symbol] _{T}_{₂} |
| 13: | end for |
| 14: | get_embeddings(H, S, Nᵤᵤ) |
| 15: | if Nᵤᵤ is None then |
| 16: | E_{I} = H ⊕ S |
| 17: | else |
| 18: | E_{I} = H ⊕ S ⊕ Nᵤᵤ, E_{α} = NS(E_{I}) |
| 19: | E_{β} = Eᵤ ⊕ σ(W^{T}(E₀ ⊕ E_{α})) |
| 20: | end if |
| 21: | end get_embeddings(H, S, Nᵤ_{ⱼ}ᵤ) |

At 506B, the first embedding associated with each user of the set of users for the item may be determined, based on the received first history information 210A, the determined first similarity information 210C, and the received social network information 210E. The circuitry 202 may be configured to determine the first embedding. The first transformer model 110A may include an item sequence header (Eᵥ_{ⱼ}) for a set of first embeddings of the set of users (for example, E_{β}^{u}^{₁} . . . E_{β}^{u}^{_{m−1}} . . . E_{β}^{u}^{ₘ}) for the item (i.e., Vⱼ). Details related to the determination of the first embedding are described further, for example, in FIG. 3 (at 308) and FIG. 5C. At 506A, second embedding associated with each item of the set of items for the user may be determined, based on the received second history information 210B and the determined second similarity information 210D of the user. The circuitry 202 may be configured to determine the second embedding. The second transformer model 110B may include the user sequence header (Eᵤ_{ᵢ}) associated with a set of second embeddings of the set of items (for example, E_{β}^{v}^{₁} . . . E_{β}^{v}^{_{m−1}} . . . E_{β}^{v}^{ₘ}) of the item (uᵢ). Details related to the determination of the second embedding are described further, for example, in FIG. 4 (at 406) and FIG. 5B.

FIG. 5B is a diagram that illustrates an exemplary first scenario for determination of an embedding for a task (T₁), in accordance with an embodiment of the disclosure. FIG. 5B is explained in conjunction with FIG. 1, FIG. 2, FIG. 3, FIG. 4, and FIG. 5A. With reference to FIGS. 5B, a first exemplary scenario 500B for first embedding determination is shown.

With reference to FIG. 5A, at 504A, for the user (uᵢ), a set of items may be masked. The circuitry 202 may be configured to mask the set of items for the user (ui). The masked array may be represented as [v₁, [mask], v₃, . . . vₘ]. The masked array for the user (uᵢ) may be lᵥ(uᵢ)^{(m)}. Similarly, at 504B, for the item (vⱼ), a set of users are masked. The circuitry 202 may be configured to mask the set of users for the item (vⱼ). The masked array may be represented as [u₁, [mask], u₃, . . . uₘ]. The masked array for the item (vⱼ) may be lᵤ(vⱼ)^{(m)}.

With reference to FIG. 5B, the second embedding associated with each item of the set of items for the user may be determined, based on the second history information 210B and the second similarity information 210D. For example, as shown in FIG. 5B, a masked array 514A (e.g., [v₁, [mask], v₃, . . . vₘ]), to mask the set of items for a user, may be provided as input to determine the second embedding 406A. Further, an item-user history 516A, i.e., H_{v,u} (e.g., the second history information 210B) and an item-item similarity 516B, i.e., S_{v,v} (e.g., the second similarity information 210D) may be received as the various other inputs for determination of the second embedding 406A. As an example, the item-user history 516A, i.e., H_{v,u}, and the item-item similarity 516B, i.e., S_{v,v}, may be determined based on the masked array 514A (e.g., [v₁, [mask], v₃, . . . vₘ]). To generate the second embedding 406A (E_{α}^{v}^{ᵢ}), a concatenation of the masked (item) array 514A [v₁, [mask], v₃ . . . vₘ] (referred as E_{α}^{v}) may be performed to determine an embedding 518A, i.e., E₀^{v}. Further, a convolution summation of the item-user history 516A and the item-item similarity 516B may be performed to determine another embedding (referred as Eₗ^{v}). The embedding Eₗ^{v} may be used to determine an embedding 520A (i.e., E_{α}^{v}^{ᵢ}). The embedding 520A (i.e., E_{α}^{v}^{ᵢ}) may be convolved with the embedding 518A (i.e., E₀^{v}). A linear project may be applied on the embedding 520A and the result of the convolution of the embeddings 520A and 518A to determine the second embedding 406A (E_{β}^{v}^{ᵢ}), which may be given as an input to the shared BERT model 102A.

FIG. 5C is a diagram that illustrates an exemplary second scenario for determination of an embedding for task (T₂), in accordance with an embodiment of the disclosure. FIG. 5C is explained in conjunction with FIG. 1, FIG. 2, FIG. 3, FIG. 4, FIG. 5A, and FIG. 5B. With reference to FIG. 5C, a second exemplary scenario 500C for second embedding determination is shown.

With reference to FIG. 5C, the first embedding associated with each user of the set of users for the item may be determined, based on the received first history information 210A, the determined first similarity information 210C, and the received social network information 210E. For example, as shown in FIG. 5C, a masked array 514B (e.g., [u₁, [mask], u₃, . . . uₘ]), to mask the set of users for an item, may be provided as input to determine the first embedding 308A. Further, a user-item history 516C, i.e., H_{u,v} (e.g., the first history information 210A), a user-user similarity 516D, i.e., S_{u,u} (e.g., the first similarity information 210C), and a user-social network 516E, i.e., N_{u,u} (e.g., the social network information 210E) may be received as the various other inputs for determination of the first embedding 308A. As an example, the user-social network 516E, i.e., N_{u,u}, may be determined based on the masked array 514B (e.g., [u₁, [mask], u₃, . . . uₘ]). The circuitry 202 may execute a convolution summation on the inputs, such as, the user-item history 516C (i.e., H_{u,v}), the user-user similarity 516D (i.e., S_{u,u}), and the user-social network 516E (i.e., N_{u,u}) to determine an embedding (Eₗ^{u}^{ⱼ}). The embedding Eₗ^{u}^{ⱼ} may be used to determine an embedding 520B (i.e., E_{β}^{u}). To generate the first embedding 308A (E_{β}^{u}^{ⱼ}), a concatenation of the masked (user) array 514B [u₁, [mask], u₃ . . . uₘ] (referred as E_{α}^{u}) may performed to determine an embedding 518B, i.e., E₀^{u}. The embedding 520B (i.e., E_{β}^{u}) may be convolved with the embedding 518B, i.e., E₀^{u}. A linear project may be applied on the embedding 520B and the result of the convolution of the embeddings 520B and 518B to determine the first embedding 308A (E_{β}^{u}^{ⱼ}), which may be given as an input to the shared BERT model 102A.

With reference to FIG. 5A, at 508, the circuitry 202 of the electronic device 102 may apply the shared BERT model 102A (for example, a first transformer model 110A and second transformer model 110B) to determine at least one recommended user for an item and/or at least one recommended item for a user. The shared BERT model 102A (for example, first transformer model 110A and second transformer model 110B) may be a neural network architecture. The shared BERT model 102A may be a machine learning model that may be trained based on test data to generate inferences based on received data input (for example, similarity information of user, history information of the user or item, social network information 210E of the user, and so on). The shared BERT model 102A may work by learning context and meaning of words from large amounts of unlabeled text data, and then fine-tuning the model for specific tasks using labeled data. The shared BERT model 102A may process both left and right context of each data input. The shared BERT model 102A may include an embedding module, a stack of encoders, and an un-embedding module. The shared BERT model 102A may be pre-trained on two tasks, such as, masked language modeling (MLM) and next-data-item prediction (for example, users or items). For example, a node associated with the user may be representative of the second embedding (uᵢ) associated with the user. Each node may be connected to a plurality of nodes that may be neighbors of the corresponding node in the graph-structured data. For example, the node associated with the user may be connected to nodes associated with users that may be determined as neighbors of the user, based on correlation information. The correlation information may be determined based on the similarity information of the set of users. In an instance, the first similarity information may be determined based on the received second correlation information.

At 510A, 510B, 512A and 512B, outputs may be obtained. The output may be the array of items in case of 510A. At 512A, the array of items for instance [0, v₂, 0, . . . 0] may include the masked value or context of the item. The output may be the array of users in 512B. At 512B, the array of users for instance [0, u₂, 0, . . . 0] may include the masked value or context of the user.

It should be noted that the shared BERT model 500A, the first scenario 500B, and the second scenario 500C are for exemplary purposes and should not be construed to limit the scope of the disclosure.

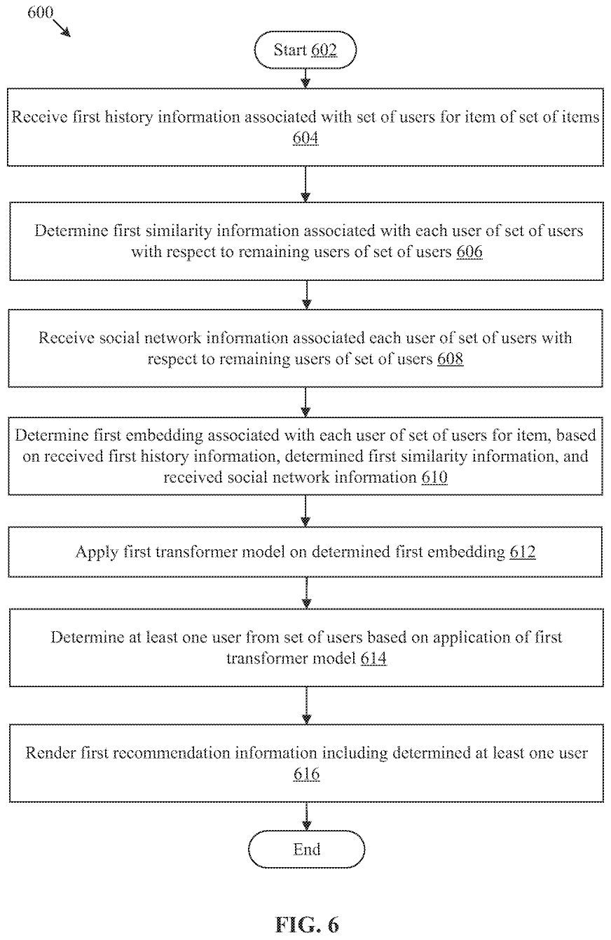

FIG. 6 is a flowchart that illustrates operations for an exemplary method for social network information-based recommendations using a transformer model, in accordance with an embodiment of the disclosure. FIG. 6 is explained in conjunction with elements from FIG. 1, FIG. 2, FIG. 3, FIG. 4, FIG. 5A, FIG. 5B, and FIG. 5C. With reference to FIG. 6, there is shown a flowchart 600. The operations from 602 to 616 may be implemented by any computing system, such as, by the electronic device 102 of FIG. 1. The operations may start at 602 and may proceed to 604.

At 604, the first history information associated with a set of users may be received for an item of a set of items. The circuitry 202 may be configured to receive the first history information (e.g., the first history information 210A) associated with a set of users (for example u1, u2, u3, . . . ) for an item of a set of items (for example v1, v2, . . . ). The history information may be stored in the first database 106A. The first database 106A may store the information (for example, similarity information and history information) associated with each item (for example, the set of items) for a set of users. The history information may include user-item history (H_{u,v}), and item-user history (H_{v,u}). The reception of the first history information is described further, for example, in FIG. 3 (at 302).

At 606, first similarity information associated with each user of the set of users with respect to remaining users of the set of users may be received. The circuitry 202 may be configured to receive the first similarity information (e.g., the first similarity information 210C) associated with each user of the set of users with respect to remaining users of the set of users. The first similarity information may be determined based on the second correlation information. The second correlation information associated with the set of items may be received for the user of the set of users. An item sequence header may be applied on the received second correlation information associated with the set of items for the user of the set of users. The item sequence header with respect to the set of items may correspond to the determined at least one user. The reception of the first similarity information is described further, for example, in FIG. 3 (at 304).

At 608, social network information associated with each user of the set of users with respect to remaining users of the set of users may be received. The circuitry 202 may be configured to receive the social network information (e.g., the social network information 210E) associated with each user of the set of users with respect to remaining users of the set of users. The social network information may include a set of relationships between the set of users on a set of social media platforms or a set of preferences corresponding to the set of items for each of the set of users. The reception of the social network information is described further, for example, in FIG. 3 (at 306).

At 610, a first embedding associated with each user of the set of users may be determined for an item, based on the received first history information, the determined first similarity information, and the social network information. The circuitry 202 may be configured to determine the first embedding (e.g., the first embedding 308A) associated with each user of the set of users for an item, based on the received first history information 210A, the determined first similarity information 210C, and the social network information 210E. The determination of the first embedding is described further, for example, in FIG. 3 (at 308), FIG. 5A and FIG. 5C.

At 612, a first transformer model is applied on the determined first embedding. The circuitry 202 may be configured to apply the first transformer model (e.g., the first transformer model 110A) on the determined first embedding (e.g., the first embedding 308A). The first transformer model 110A may include an objective function L to determine a first recommendation including at least one user. A parameter L₁ may represent cross entropy loss function for a task T₁. A parameter L₂ may represent cross entropy loss function for a task T₂. In an embodiment, the second correlation information corresponds to masked user from the set of users, for the item, and the first transformer model 110A may be trained based on the masked user corresponding to the item. The first transformer model 110A may include the item sequence header (Eᵥ_{ⱼ}) associated with the set of first embeddings associated with the set of users (for example, E_{β}^{u}^{₁} . . . . E_{β}^{u}^{_{m−1}} . . . E_{β}^{u}^{ₘ}) of the item (Vⱼ). The application of the first transformer model is described further, for example, in FIG. 3 (at 310), FIG. 5A and FIG. 5C.

At 614, at least one user may be determined from the set of users based on the application of the first transformer model. The circuitry 202 may be configured to determine at least one user from the set of users based on the application of the first transformer model 110A. The first transformer model 110A may determine inferences from the determined first embeddings fed to the first transformer model 110A. The inferences may be received for example, as an array, such as, (0, u₂, 0 . . . 0). The determination of the at least one user is described further, for example, in FIG. 3 (at 312) and FIG. 5A.

At 616, first recommendation information including the determined at least one user for the item may be rendered. The circuitry 202 may be configured to render first information including the determined at least one user for the item on a display device 102B associated with the electronic device 102. Control may pass to end.

Although the flowchart 600 is illustrated as discrete operations, such as 604, 606, 608, 610, 612, 614, and 616, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (such as the electronic device 102). The computer-executable instructions may cause the machine and/or computer to perform operations that include social network information-based recommendation using transformer model. The operations may include reception of first history information associated with a set of users for an item of a set of items. The operations may further include determination of first similarity information associated with each user of the set of users with respect to remaining users of the set of users. The operations may further include determination of a first embedding associated with each user of the set of users for the item, based on the received first history information, the determined first similarity information, and the received social network information. The operation may further include application of a first transformer model (e.g., the first transformer model 110A) on the determined first embedding and determination of at least one user from the set of users based on the application of the first transformer model 110A. The operations may further include rendering of first recommendation information including the determined at least one user for the item.

Exemplary aspects of the disclosure may include an electronic device (such as, the electronic device 102 of FIG. 1) that may include circuitry (such as, the circuitry 202), that may be communicatively coupled to the electronic device (such as, the electronic device 102 of FIG. 1). The electronic device 102 may further include memory (such as, the memory 204 of FIG. 2). The circuitry 202 may be configured to receive first history information associated with a set of users for an item of a set of items. The circuitry 202 may be configured to determine first similarity information associated with each user of the set of users with respect to remaining users of the set of users. The circuitry 202 may be further configured to receive social network information associated each user of the set of users with respect to remaining users of the set of users. The circuitry 202 may be configured to determine a first embedding associated with each user of the set of users for the item, based on the received first history information, the determined first similarity information, and the received social network information. The circuitry 202 may be further configured to apply a first transformer model (e.g., the first transformer model 110A) on the determined first embedding and determine at least one user from the set of users based on the application of the first transformer model 110A. Further, the circuitry 202 may be configured to render first recommendation information including the determined at least one user for the item.

In accordance with an embodiment, the circuitry 202 may be further configured to receive second history information associated with the set of items for the user of the set of users and determine second similarity information associated with each item of the set of items with respect to remaining items of the set of items. Further, the circuitry 202 may be configured to determine a second embedding associated with each item of the set of items for the user, based on the received second history information and the determined second similarity information. The circuitry 202 may be configured to apply a second transformer model (e.g., the second transformer model 110B) on the determined second embedding. The circuitry 202 may be further configured to determine at least one item from the set of items based on the application of the second transformer model 110B and render second recommendation information including the determined at least one item for the user.

In accordance with an embodiment, each of the first transformer model 110A and the second transformer model 110B may correspond to a shared Bidirectional Encoder Representations from Transformers (BERT) model (e.g., the shared BERT model 102A).

In accordance with an embodiment, the circuitry 202 may be further configured to receive first correlation information associated with the set of items for the user of the set of users and the second similarity information may be determined based on the received first correlation information.

In accordance with an embodiment, the circuitry 202 may be further configured to apply a user sequence header on the received first correlation information associated with the set of items for the user of the set of users and the user sequence header with respect to the set of users may correspond to the determined at least one item.

In accordance with an embodiment, the first correlation information may correspond to a masked item from the set of items, for the user and the second transformer model 110B may be trained based on the masked item corresponding to the user.

In accordance with an embodiment, the circuitry 202 may be further configured to determine first neighborhood information associated with the set of items for the user of the set of users, based on the determined first correlation information. The determination of the at least one user from the set of users may be further based on the determined first neighborhood information. The first neighborhood information may be indicative of each user of the set of users correlated with the item.

In accordance with an embodiment, the circuitry 202 may be further configured to receive second correlation information associated with the set of items for the user of the set of users. The first similarity information may be determined based on the received second correlation information.

In accordance with an embodiment, the circuitry 202 may be further configured to apply an item sequence header on the received second correlation information associated with the set of items for the user of the set of users and the item sequence header with respect to the set of items may correspond to the determined at least one user.

In accordance with an embodiment, the second correlation information may correspond to a masked user from the set of users, for the item and the first transformer model 110A may be trained based on the masked user corresponding to the item.

In accordance with an embodiment, the circuitry 202 may be further configured to determine second neighborhood information associated with each item of the set of items for the user, based on the determined second correlation information. The determination of the at least one item from the set of items may be further based on the determined second neighborhood information and the second neighborhood information may be indicative of each item of the set of items correlated with the user.

In accordance with an embodiment, the social network information may include a set of relationships between the set of users on a set of social media platforms or a set of preferences corresponding to the set of items for each of the set of users.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. An electronic device, comprising:
circuitry configured to:
receive first history information associated with a set of users for an item of a set of items;
determine first similarity information associated with each user of the set of users with respect to remaining users of the set of users;
receive social network information associated each user of the set of users with respect to remaining users of the set of users;
determine a first embedding associated with each user of the set of users for the item, based on the received first history information, the determined first similarity information, and the received social network information;
apply a first transformer model on the determined first embedding;
determine at least one user from the set of users based on the application of the first transformer model; and
render first recommendation information including the determined at least one user for the item.

2. The electronic device according to claim 1, wherein the circuitry is further configured to:
receive second history information associated with the set of items for the user of the set of users;
determine second similarity information associated with each item of the set of items with respect to remaining items of the set of items;
determine a second embedding associated with each item of the set of items for the user, based on the received second history information and the determined second similarity information;
apply a second transformer model on the determined second embedding;
determine at least one item from the set of items based on the application of the second transformer model; and
render second recommendation information including the determined at least one item for the user.

3. The electronic device according to claim 2, wherein each of the first transformer model and the second transformer model corresponds to a shared Bidirectional Encoder Representations from Transformers (BERT) model.

4. The electronic device according to claim 2, wherein the circuitry is further configured to:
receive first correlation information associated with the set of items for the user of the set of users, wherein
the second similarity information is determined based on the received first correlation information.

5. The electronic device according to claim 4, wherein the circuitry is further configured to:
apply a user sequence header on the received first correlation information associated with the set of items for the user of the set of users, wherein
the user sequence header corresponds to the determined at least one item.

6. The electronic device according to claim 4, wherein
the first correlation information corresponds to a masked item from the set of items, for the user, and
the second transformer model is trained based on the masked item corresponding to the user.

7. The electronic device according to claim 4, wherein the circuitry is further configured to:
determine first neighborhood information associated with the set of items for the user of the set of users, based on the determined first correlation information, wherein
the determination of the at least one item from the set of items is further based on the determined first neighborhood information, and
the first neighborhood information is indicative of each item of the set of items correlated with the user.

8. The electronic device according to claim 1, wherein the circuitry is further configured to:
receive second correlation information associated with the set of users for the item of the set of items, wherein
the first similarity information is determined based on the received second correlation information.

9. The electronic device according to claim 8, wherein the circuitry is further configured to:
apply an item sequence header on the received second correlation information associated with the set of users for the item of the set of items, wherein
the item sequence header corresponds to the determined at least one user.

10. The electronic device according to claim 8, wherein
the second correlation information corresponds to a masked user from the set of users, for the item, and
the first transformer model is trained based on the masked user corresponding to the item.

11. The electronic device according to claim 8, wherein the circuitry is further configured to:
determine second neighborhood information associated with the set of users for the item of the set of items, based on the determined second correlation information, wherein
the determination of the at least one user from the set of users is further based on the determined second neighborhood information, and
the second neighborhood information is indicative of each user of the set of users correlated with the item.

12. The electronic device according to claim 1, wherein the social network information includes at least one of:
a set of relationships between the set of users on a set of social network platforms, or
a set of preferences corresponding to the set of items for each user of the set of users.

13. A method, comprising:
in an electronic device:
receiving first history information associated with a set of users for an item of a set of items;
determining first similarity information associated with each user of the set of users with respect to remaining users of the set of users;
receiving social network information associated each user of the set of users with respect to remaining users of the set of users;
determining a first embedding associated with each user of the set of users for the item, based on the received first history information, the determined first similarity information, and the received social network information;
applying a first transformer model on the determined first embedding;
determining at least one user from the set of users based on the application of the first transformer model; and
rendering first recommendation information including the determined at least one user for the item.

14. The method according to claim 13, further comprising:
receiving second history information associated with the set of items for the user of the set of users;
determining second similarity information associated with each item of the set of items with respect to remaining items of the set of items;
determining a second embedding associated with each item of the set of items for the user, based on the received second history information and the determined second similarity information;
applying a second transformer model on the determined second embedding;
determining at least one item from the set of items based on the application of the second transformer model; and
rendering second recommendation information including the determined at least one item for the user.

15. The method according to claim 14, further comprising:
receiving first correlation information associated with the set of items for the user of the set of users, wherein
the second similarity information is determined based on the received first correlation information.

16. The method according to claim 15, further comprising:
applying a user sequence header on the received first correlation information associated with the set of items for the user of the set of users, wherein
the user sequence header corresponds to the determined at least one item.

17. The method according to claim 15, further comprising:
determining first neighborhood information associated with the set of items for the user of the set of users, based on the determined first correlation information, wherein
the determination of the at least one item from the set of items is further based on the determined first neighborhood information, and
the first neighborhood information is indicative of each item of the set of items correlated with the user.

18. The method according to claim 13, further comprising:
receiving second correlation information associated with the set of users for the item of the set of items, wherein
the first similarity information is determined based on the received second correlation information.

19. The method according to claim 18, further comprising:
apply an item sequence header on the received second correlation information associated with the set of users for the item of the set of items, wherein
the item sequence header corresponds to the determined at least one user.

20. A non-transitory computer-readable medium having stored thereon, computer-executable instructions that when executed by an electronic device, causes the electronic device to execute operations, the operations comprising:
receiving first history information associated with a set of users for an item of a set of items;
determining first similarity information associated with each user of the set of users with respect to remaining users of the set of users;
receiving social network information associated each user of the set of users with respect to remaining users of the set of users;
determining a first embedding associated with each user of the set of users for the item, based on the received first history information, the determined first similarity information, and the received social network information;
applying a first transformer model on the determined first embedding;
determining at least one user from the set of users based on the application of the first transformer model; and
rendering first recommendation information including the determined at least one user for the item.
